(19) United States
(12) Patent Application Publication
(10) Pub. No.: US 2022/0163817 A1
(43) Pub. Date: May 26, 2022

(54) STEREOSCOPIC EMBLEM

(71) Applicants: NIPPON CARBIDE INDUSTRIES CO., INC., Tokyo (JP); HAYASHI TELEMPU CORPORATION, Nagoya (JP)

(72) Inventors: Taketoshi Hayashi, Tokyo (JP); Arito Kurobe, Nagoya (JP)

(73) Assignees: NIPPON CARBIDE INDUSTRIES CO., INC., Tokyo (JP); HAYASHI TELEMPU CORPORATION, Nagoya (JP)

(21) Appl. No.: 17/527,821

(22) Filed: Nov. 16, 2021

(30) Foreign Application Priority Data
Nov. 24, 2020 (JP) 2020-194195

(51) Int. Cl. G02B 30/50; G02B 5/26

(52) U.S. Cl. CPC G02B 30/50; G02B 5/26

(57) ABSTRACT

A stereoscopic emblem includes: a retroreflective sheeting in which a surface on one side where light is incident and emitted protrudes and a recess is formed on a surface on the other side facing the protruding surface on the one side; a cured resin provided in the recess; and an adhesive layer provided on a side opposite to the retroreflective sheeting side with respect to the cured resin.

### BACKGROUND ART

The present invention relates to a stereoscopic emblem.

Conventionally, as an emblem for decorating a vehicle body surface or the like of an automobile, a stereoscopic emblem having metallic luster is known, and for example, a stereoscopic emblem of the following Patent Literature 1 has been proposed. The stereoscopic emblem described in Patent Literature 1 is formed by processing a thermoplastic film in which a metallic luster film is stacked on one surface into a stereoscopic shape.

### [Patent Literature 1] JP 2003-202808 A

### SUMMARY OF INVENTION

However, in the stereoscopic emblem described in Patent Literature 1, since the metallic luster film is merely stacked on the thermoplastic film, there is a concern that the stereoscopic emblem melts into darkness at night or in a dark place and becomes difficult to recognize. Therefore, a stereoscopic emblem that is easily recognized even at night or in a dark place is required.

Therefore, an object of the present invention is to provide a stereoscopic emblem that is easily recognized even at night or in a dark place.

In order to achieve the above object, a stereoscopic emblem of the present invention includes: a retroreflective sheeting in which a surface on one side where light is incident and emitted protrudes and a recess is formed on a surface on the other side facing the protruding surface on the one side; a cured resin provided in the recess; and an adhesive layer provided on a side opposite to the retroreflective sheeting side with respect to the cured resin.

In the stereoscopic emblem, the retroreflective sheeting protrudes to one side where light is incident and emitted. By protruding the retroreflective sheeting in this manner, a desired stereoscopic shape representing predetermined characters, patterns, figures, and the like can be formed on the side opposite to the adhesive layer side. Therefore, when the stereoscopic emblem is irradiated with light at night or in a dark place, the light is retroreflected by the retroreflective sheeting without being blocked by the cured resin. Therefore, a viewer can clearly recognize the stereoscopic emblem through the retroreflected light even at night or in a dark place. On the other hand, in the daytime or in the bright place, the viewer can directly view the stereoscopic emblem.

In addition, in the stereoscopic emblem, since the cured resin is provided in the recess, the rigidity of the stereoscopic emblem can be enhanced by the cured resin. Therefore, unnecessary deformation of the stereoscopic emblem can be suppressed.

In addition, the stereoscopic emblem may further include a thermoplastic resin layer stacked between the retroreflective element layer and the cured resin.

By further providing the thermoplastic resin layer between the retroreflective element layer and the cured resin in this manner, the rigidity of the stereoscopic emblem can be reinforced.

In addition, the stereoscopic emblem may further include a surface protective layer stacked on a side opposite to the retroreflective element layer side with respect to a holding body layer.

Such a surface protective layer can effectively protect the retroreflective sheeting.

In addition, in a cross section along a thickness direction of the stereoscopic emblem, the retroreflective sheeting may include a vertex and a side portion forming the recess, and in the cross section, the side portion may be inclined outward from the vertex with respect to a line extending from the vertex along the thickness direction.

According to such a configuration, in a front view of the stereoscopic emblem viewed from a vertex side, a width of the stereoscopic emblem can be widened as compared with a case where the side portion is parallel to the above line. Therefore, characters, patterns, and figures represented by the stereoscopic emblem can be made bold.

As described above, according to the present invention, the stereoscopic emblem that is easily recognized even at night or in a dark place can be provided.

### BRIEF DESCRIPTION OF DRAWINGS

FIG. 1 is a front view illustrating an example of a stereoscopic emblem according to a first embodiment of the present invention;

FIG. 2 is a cross-sectional view taken along line II-II of FIG. 1;

FIG. 3 is a cross-sectional view along a thickness direction schematically illustrating a part and the like of a retroreflective sheeting illustrated in FIG. 2;

FIG. 4 is a flowchart illustrating an example of a method of manufacturing a stereoscopic emblem illustrated in FIG. 1;

FIG. 5 is a diagram illustrating a state of a lamination process of a first embodiment;

FIG. 6 is a diagram illustrating a state before pressing in a molding process of the first embodiment;

FIG. 7 is a diagram illustrating a state after the pressing in the molding process of the first embodiment;

FIG. 8 is a diagram illustrating a configuration example of a filling device used in a filling process;

FIG. 9 is a diagram illustrating a state before filling in the filling process of the first embodiment;

FIG. 10 is a diagram illustrating a state during the filling in the filling process of the first embodiment;

FIG. 11 is a diagram illustrating a part and the like of a retroreflective sheeting according to a second embodiment of the present invention from the same viewpoint as FIG. 2;

FIG. 12 is a flowchart illustrating an example of a method of manufacturing a stereoscopic emblem illustrated in FIG. 11;

FIG. 13 is a diagram illustrating a state of a lamination process of a second embodiment;

FIG. 14 is a diagram illustrating a state before pressing in a molding process of the second embodiment;

FIG. 15 is a diagram illustrating a state after the pressing in the molding process of the second embodiment;

FIG. 16 is a diagram illustrating a state before the filling in the filling process of the second embodiment; and

FIG. 17 is a diagram illustrating a state during the filling in the filling process of the second embodiment.

### DESCRIPTION OF EMBODIMENTS

Hereinafter, modes for carrying out a stereoscopic emblem according to the present invention will be exemplified together with the accompanying drawings. Embodiments exemplified below are intended to facilitate understanding of the present invention and are not intended to limit the present invention. The present invention can be modified and improved from the following embodiments without departing from the gist thereof. In addition, in the present specification, dimensions of each member may be exaggerated for easy understanding.

### First Embodiment

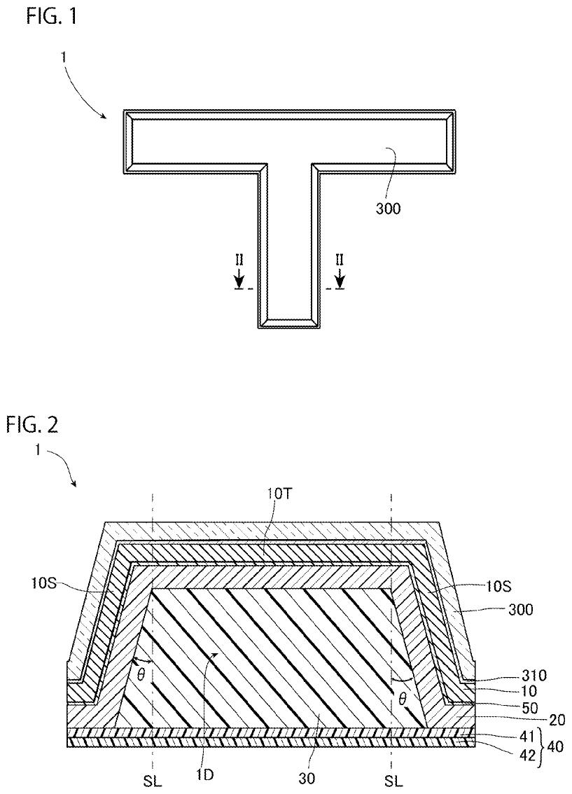

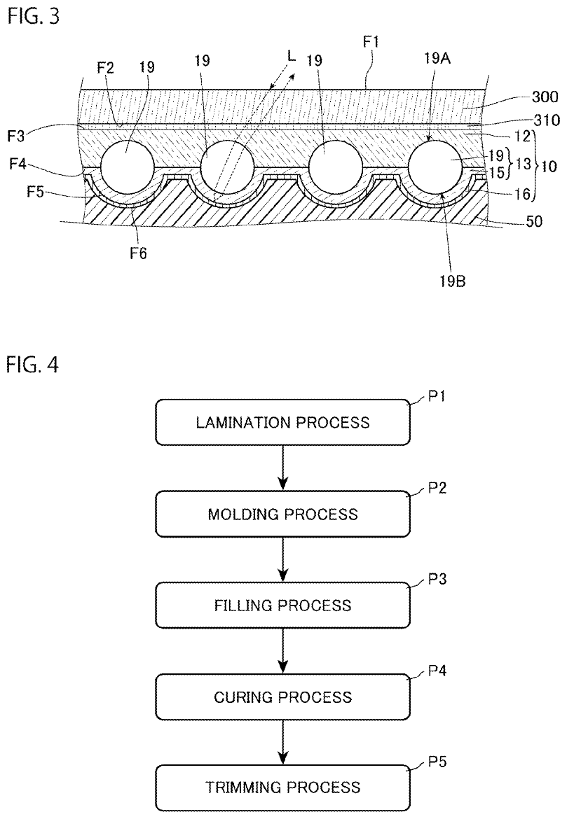

FIG. 1 is a front view illustrating an example of a stereoscopic emblem according to the present embodiment. FIG. 2 is a cross-sectional view taken along line II-II of FIG. 1, and is a cross-sectional view taken along thickness direction of the stereoscopic emblem. FIG. 3 is a cross-sectional view along a thickness direction schematically illustrating a part and the like of a retroreflective sheeting illustrated in FIG. 2.

As illustrated in FIGS. 1 to 3, a stereoscopic emblem mainly includes a surface protective layer 300, a retroreflective sheeting 10, a thermoplastic resin layer 20, a cured resin 30, and an adhesive layer 40, and has a configuration in which these layers are stacked.

The surface protective layer 300 is a light transmissive layer that covers the surface of the retroreflective sheeting 10, and has a surface F1 that is the front-most surface of the stereoscopic emblem 1 and a surface F2 opposite to the surface F1 as illustrated in FIG. 3. In the present embodiment, light L is incident on and emitted from the stereoscopic emblem 1 via a surface F1. A material of the surface protective layer 300 is not particularly limited, but usually, resins such as an acrylic resin, an alkyd resin, a fluororesin, a vinyl chloride resin, a polyester resin, a urethane resin, and a polycarbonate resin can be used alone or in combination. Among them, it is preferable to use an acrylic resin, a polyester resin, or a vinyl chloride resin from the viewpoint of weather resistance and processability, and it is particularly preferable to use an acrylic resin or a polyester resin in consideration of coating suitability, dispersibility of a colorant in coloring, and the like. The thickness of the surface protective layer 300 is not particularly limited, but may be, for example, 60 μm or more and 120 μm or less.

A light transmissive adhesive layer 310 is provided on the surface F2 of the surface protective layer 300. A surface F3 on one side of the retroreflective sheeting 10 is adhered to the surface protective layer 300 via the adhesive layer 310. Note that examples of the material of the adhesive layer 310 can include an acrylic resin, an epoxy resin, a phenol resin, a vinyl acetate resin, a nitrile rubber resin, a silicone rubber resin. In addition, the thickness of the adhesive layer 310 is not particularly limited, but may be, for example, 20 μm or more and 60 μm or less.

The surface of the retroreflective sheeting 10 on the other side opposite to the surface protective layer 300 side is bonded to the thermoplastic resin layer 20 via the adhesive layer 50. Examples of the material for forming the adhesive layer 50 can include the same material as the adhesive layer 310 described above. However, the adhesive layer 50 may be opaque. In addition, the thickness of the adhesive layer 50 is not particularly limited, but may be, for example, 30 μm or more and 35 μm or less.

The thermoplastic resin layer 20 is a layer made of a thermoplastic resin. The material for forming the thermoplastic resin layer 20 is not particularly limited, and examples thereof can include an acrylonitrile butadiene styrene (ABS) resin, a polycarbonate (PC) resin, and a polyethylene terephthalate (PET) resin. In addition, the thickness of the thermoplastic resin layer 20 is not particularly limited, but may be, for example, 170 μm or more and 230 μm or less.

As described above, a laminate in which the surface protective layer 300, the retroreflective sheeting 10, and the thermoplastic resin layer 20 are stacked in this order from the front side to the back side is embossed such that one side, which is the surface protective layer 300 side, protrudes and a recess 1D is formed on the thermoplastic resin layer 20 side, which is the other side facing the protruding one side, as shown in FIG. 2. As illustrated in FIG. 1, in the present embodiment, the laminate including the surface protective layer 300, the retroreflective sheeting 10, and the thermoplastic resin layer 20 protrudes as described above, so that the stereoscopic emblem 1 has a stereoscopic shape having a substantially T-shaped protrusion.

In the cross section taken along the thickness direction illustrated in FIG. 2, the retroreflective sheeting 10 according to the present embodiment includes a vertex 10T and a side portion 10S that form the recess 1D. In this cross section, the side portion 10S is inclined outward from the vertex 10T at a predetermined angle θ with respect to a line SL extending from the vertex 10T along the thickness direction. An angle θ of the inclination may be, for example, more than 0° and 45° or less, or more than 0° and 15° or less.

The cured resin 30 is filled in the recess 1D. Examples of the material used for the cured resin 30 can include a thermosetting resin and an ultraviolet curable resin. Examples of the thermosetting resin can include a urethane resin, an epoxy resin, a silicon resins, and examples of the ultraviolet curable resin can include a radically polymerized acrylic resin, a cationically polymerized epoxy resin. In the case of the thermosetting resin, a two-liquid type in which a cured resin and a crosslinking agent are mixed immediately before use may be adopted. Examples of such a two-liquid type thermosetting resin can include a two-liquid cured non-foamed urethane resin. Note that as a component of the cured resin 30, any one or more of a crosslinking agent, a polymerization initiator, a stabilizer, a flame retardant, an antioxidant, an antistatic agent, a fungicide, and the like may be contained.

The adhesive layer 40 is provided on the side opposite to the retroreflective sheeting 10 with the cured resin 30 as a reference. In the present embodiment, the adhesive layer 40 is a tape-shaped member, and seals the cured resin 30 filled in the recess 1D. The thickness of the adhesive layer 40 is not particularly limited, but may be, for example, 120 μm or more and 130 μm or less. The adhesive layer 40 in the present embodiment includes an adhesive agent layer 41 that adheres to each of the cured resin 30 and the thermoplastic resin layer 20, and release paper 42 that is bonded to one surface of the adhesive agent layer 41. When the stereoscopic emblem 1 is used, the release paper 42 is peeled off to expose the surface of the adhesive agent layer 41 on the side opposite to the cured resin 30 side, and this surface is attached to the object, so the stereoscopic emblem 1 can be attached to the object.

Next, the retroreflective sheeting 10 will be described in detail.

As illustrated in FIG. 3, the retroreflective sheeting according to the present embodiment is a so-called encapsulated bead type retroreflective sheeting. The retroreflective sheeting 10 includes a holding body layer 12 and a retroreflective element layer 13 as main components, and has a configuration in which these layers are stacked. The thickness of the retroreflective sheeting 10 is not particularly limited, but may be, for example, 98 μm or more and 105 μm or less.

The holding body layer 12 is a layer that holds microglass spheres, which will be described later, of the retroreflective element layer 13, and has optical transparency. The adhesive layer 310 is provided on the surface F3 on one side of the holding body layer 12, and the retroreflective element layer 13 is stacked on a surface F4 on the other side. In the present embodiment, the surface F3 of the holding body layer 12 is the outermost surface of the retroreflective sheeting 10, and protrudes by the embossing molding. As a material for forming the holding body layer 12, usually, resins such as an acrylic resin, an alkyd resin, a fluororesin, a vinyl chloride resin, a polyester resin, a urethane resin, and a polycarbonate resin can be used alone or in combination. It is preferable to use an acrylic resin, a polyester resin, or a vinyl chloride resin from the viewpoint of weather resistance and processability, and it is preferable to use an acrylic resin when considering coating suitability, dispersibility of a colorant in coloring, and the like.

The retroreflective element layer 13 includes a plurality of microglass spheres 19 and a focus forming layer 15.

The focus forming layer 15 is a layer for arranging a specular reflection layer 16 to be described later at a focal position of the microglass sphere 19, and has optical transparency. As a material for forming the focus forming layer 15, usually, resins such as an acrylic resin, an alkyd resin, a fluororesin, a vinyl chloride resin, a polyester resin, a urethane resin, a polycarbonate resin, and a butyral resin can be used alone or in combination. Note that it is preferable to use an acrylic resin from the viewpoint of weather resistance, coating suitability, and thermal stability.

The plurality of microglass spheres 19 preferably has a diameter of, for example, 20 μm to 150 μm, more preferably 30 μm to 120 μm, still more preferably 50 μm to 100 μm, and are arranged at predetermined intervals. The spherical surface 19A of the substantially upper half of each of the microglass spheres 19 is enclosed inside the holding body layer 12 from the surface F4 on the other side of the holding body layer 12, whereby the plurality of microglass spheres 19 is held by the holding body layer 12. The focus forming layer 15 covers the surface F4 on the other side of the holding body layer 12 and a spherical surface 19B of the substantially lower half of the microglass sphere 19 not enclosed in the holding body layer 12.

The specular reflection layer 16 is a layer for reflecting light transmitted through the microglass sphere 19. The specular reflection layer 16 is stacked on a surface F5 of the focus forming layer 15 on the side opposite to the holding body layer 12 side, and is arranged at the focal position of each of the plurality of microglass spheres 19 via the focus forming layer 15. In the present embodiment, a surface F6 of the specular reflection layer 16 on the side opposite to the focus forming layer 15 is a backmost surface of the retroreflective sheeting 10 and is the other surface facing the surface F3 of the holding body layer 12. A recess is formed on the surface F6 by the embossing. The specular reflection layer 16 may be formed by means such as a vacuum vapor deposition method or a sputtering method using metals such as aluminum, silver, chromium, nickel, magnesium, gold, or tin, for example. Note that in order to uniformly form a metal thin film reflecting the shape of the focus forming layer 15, a vapor deposition method is preferable.

As illustrated in FIG. 3, when the light L enters from the surface F1 of the surface protective layer 300, the light L is incident on the holding body layer 12 from the surface F3 on one side of the retroreflective sheeting 10, and transmits the microglass spheres 19 and the light transmissive focus forming layer 15. As described above, the specular reflection layer 16 is disposed at a focal position of the microglass sphere 19 via the focus forming layer 15. Therefore, after transmitting the focus forming layer 15, the light L is retroreflected by the specular reflection layer 16 located at the focal point of the microglass sphere 19. Thereafter, the light L is transmitted through the microglass sphere 19 and the holding body layer 12, emitted from the surface F3 on one side of the retroreflective sheeting 10 into the surface protective layer 300, transmitted through the surface protective layer 300, and then emitted from the surface F1 to the outside of the stereoscopic emblem 1.

As described above, the stereoscopic emblem 1 of the present embodiment includes the retroreflective sheeting 10 in which the surface F3 on one side where the light L is incident and emitted protrudes and the recess 1D is formed on the surface F6 on the other side facing the surface F3 protruding on the one side, the cured resin 30 which is provided in the recess 1D, and the adhesive layer 40 that is provided on the opposite side to the retroreflective sheeting 10 side with respect to the cured resin 30.

In the stereoscopic emblem 1, the retroreflective sheeting 10 protrudes to one side where the light L is incident and emitted. By protruding the retroreflective sheeting 10 in this manner, a desired stereoscopic shape representing predetermined characters, patterns, figures, and the like can be formed on the side opposite to the adhesive layer 40 side. Therefore, when the stereoscopic emblem 1 is irradiated with the light L at night or in a dark place, the light L is retroreflected by the retroreflective sheeting 10 without being blocked by the cured resin 30. Therefore, a viewer can clearly recognize the stereoscopic emblem through the retroreflected light L even at night or in a dark place. On the other hand, in the daytime or in the bright place, the viewer can directly view the stereoscopic emblem.

In addition, in the stereoscopic emblem 1, since the cured resin 30 is provided in the recess 1D, the rigidity of the stereoscopic emblem can be enhanced by the cured resin 30. Therefore, unnecessary deformation of the stereoscopic emblem can be suppressed.

In addition, since the stereoscopic emblem 1 of the present embodiment includes the thermoplastic resin layer 20 stacked between the retroreflective sheeting 10 and the cured resin 30, the rigidity of the stereoscopic emblem 1 can be reinforced as compared with a case where such a thermoplastic resin layer 20 is not included.

In addition, the stereoscopic emblem 1 of the present embodiment further includes the surface protective layer 300 stacked on the side opposite to the adhesive layer 40 side with respect to the retroreflective sheeting 10. Such a surface protective layer 300 can effectively protect the retroreflective sheeting 10.

In addition, in the present embodiment, the side portion 10S of the retroreflective sheeting 10 is inclined outward from the vertex 10T with respect to the line SL. According to such a configuration, in the front view in which the stereoscopic emblem 1 is viewed from the vertex 10T side, the width of the stereoscopic emblem can be widened as compared with the case where the side portion 10S is parallel to the line SL. Therefore, characters, patterns, and figures represented by the stereoscopic emblem 1 can be made bold.

Next, an example of a method of manufacturing the stereoscopic emblem 1 of the present embodiment will be described.

FIG. 4 is a flowchart illustrating an example of a method of manufacturing the stereoscopic emblem 1. As illustrated in FIG. 4, the method of manufacturing the stereoscopic emblem 1 includes a lamination process P1, a molding process P2, a filling process P3, a curing process P4, and a trimming process P5 as main processes.

### Lamination Process P1

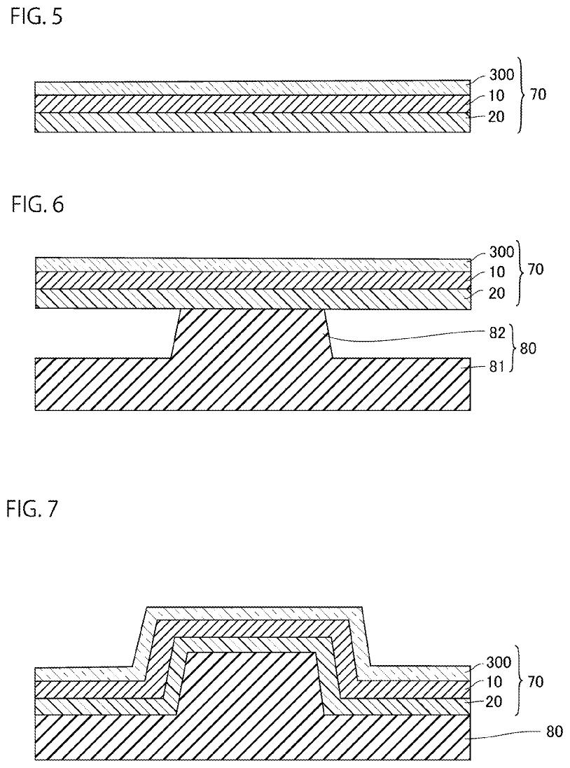

FIG. 5 is a diagram illustrating a state of this process. As illustrated in FIG. 5, first, the surface protective layer 300 is bonded to the surface on one side of the retroreflective sheeting 10 via the adhesive layer 310. In addition, the thermoplastic resin layer 20 is bonded to the surface on the other side of the retroreflective sheeting 10 via the adhesive layer 50. In this way, a laminate 70 including the surface protective layer 300, the retroreflective sheeting 10, and the thermoplastic resin layer 20 is formed.

Note that illustration of the adhesive layer 50 and the adhesive layer 310 is omitted in FIG. 5 and FIGS. 6, 7, 9, and 10 described later for convenience.

### Molding Process P2

FIG. 6 is a diagram illustrating a state before embossing molding in this process. FIG. 7 is a diagram illustrating a state after the embossing molding in this process. As illustrated in FIG. 6, in this process, the laminate 70 is embossed using a convex mold 80. The convex mold 80 includes a flat plate portion 81 having a flat plate shape and a protrusion 82 protruding from the flat plate portion 81. The protrusion 82 is formed in a trapezoidal shape whose width decreases with distance from the flat plate portion 81. In this process, first, the laminate 70 is mounted on the protrusion 82 such that the surface of the laminate 70 on the thermoplastic resin layer 20 side faces the protrusion 82 of the convex mold 80.

Next, as illustrated in FIG. 7, the laminate 70 is embossed by, for example, vacuum or pressure molding so that the surface protective layer 300 side of the laminate 70 protrudes. Alternatively, the surface protective layer 300 side of the laminate 70 may protrude by pressing the convex mold and the concave mold onto the laminate 70. Note that in this process, it is preferable to heat and soften the laminate 70 and then emboss the laminate.

In this way, the predetermined embossed shape is transferred to the laminate 70. In the present embodiment, a trapezoidal recess is formed when viewed from the thermoplastic resin layer 20 side of the laminate 70, and a trapezoidal protrusion is formed when viewed from the surface protective layer 300 side of the laminate 70. Note that the shape of the protrusion formed in the laminate 70 by the embossing is characters, symbols, figures, or the like.

### Filling Process P3

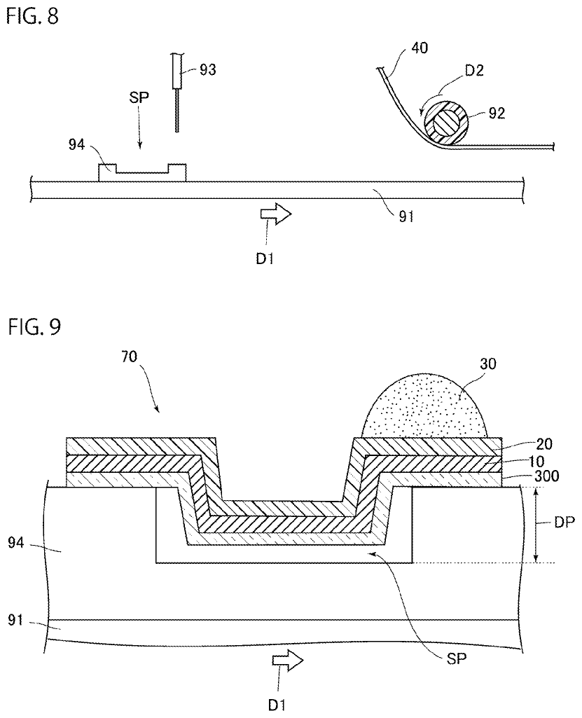

FIG. 8 is a diagram illustrating a configuration example of a filling device used in this process. As illustrated in FIG. 8, in the case of the present embodiment, for example, this process is performed using a filling device including a conveyance path 91, a pressing roller 92, a resin injection nozzle 93, and a pedestal 94 as main components.

The conveyance path 91 is, for example, a belt conveyor type conveyance path. The pedestal 94 mounted on the conveyance path moves in a conveyance direction Dl. A mounting surface of the pedestal 94 is provided with an accommodation space SP for accommodating the protrusion formed on the laminate 70 in the molding process P2.

The pressing roller 92 is a lifting roller that is disposed above the conveyance path 91 and moves up and down in a direction toward or away from the conveyance path 91 in the present embodiment. A rotation direction D2 of the pressing roller 92 is the same direction as the conveyance direction D1, and the surface of the pressing roller 92 is made of, for example, rubber.

The adhesive layer 40 is disposed between the pressing roller 92 and the conveyance path 91. Note that the release paper 42 side of the adhesive layer 40 faces the roller surface of the pressing roller 92, and the adhesive agent layer 41 side of the adhesive layer 40 faces the conveyance surface of the conveyance path 91. The adhesive layer 40 is moved at a predetermined speed in the conveyance direction D1 of the conveyance path 91 by the feeding mechanism.

The resin injection nozzle 93 is disposed above the conveyance path 91 and on the upstream side of the pressing roller 92 in the conveyance direction D1, and is configured to inject a prescribed amount of the cured resin 30 at a predetermined pressure.

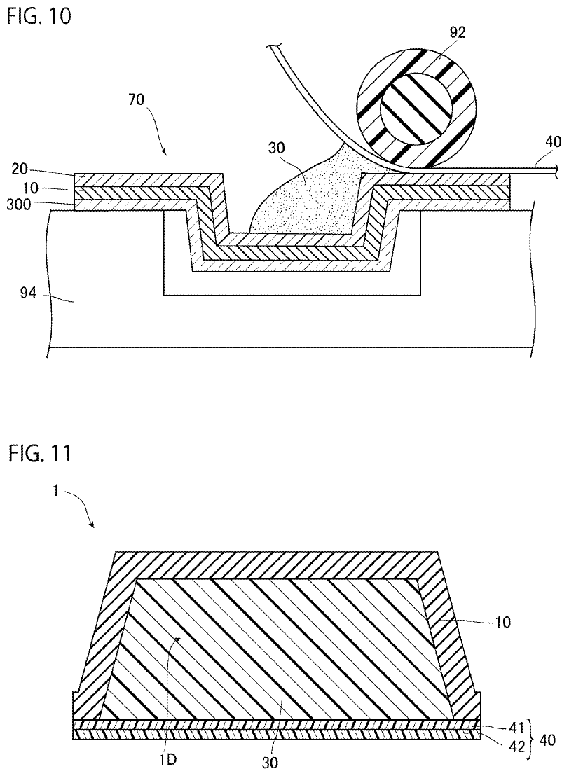

FIG. 9 is a diagram illustrating a state before filling in this process. FIG. 10 is a diagram illustrating a state during filling in this process. As illustrated in FIG. 9, first, the laminate 70 is mounted on the pedestal 94 in a state where the protrusion formed on the laminate 70 is accommodated in the accommodation space SP of the pedestal 94.

Note that in order to prevent the protrusion of the laminate 70 from being deformed by the pressing, a depth DP of the accommodation space SP is preferably set to such a depth as to have a gap with the protrusion of the laminate 70 mounted on the pedestal 94.

Next, the cured resin 30 is injected at a predetermined pressure by a predetermined amount through the resin injection nozzle 93 with respect to a first portion other than the recess in the surface of the laminate 70 on the thermoplastic resin layer 20 side, and the cured resin 30 is disposed at the first portion.

In the case of the present embodiment, first, the pressing roller 92 is disposed on the downstream side in the conveyance direction D1 with respect to the recess in the peripheral edge of the recess. Next, the pedestal 94 moves in the conveyance direction D1, and the pressing roller 92 rotates in the rotation direction D2. In this way, as illustrated in FIG. 10, the adhesive layer 40 is pressed against the first portion by the pressing roller 92. In this state, the pressing roller 92 passes above the recess from the first portion and moves to the second portion other than the recess. As a result, the adhesive layer 40 is pressure-bonded to the surface of the laminate 70 on the thermoplastic resin layer 20 side, and the recess of the laminate 70 is filled with the cured resin 30. In addition, the cured resin 30 that has not filled in the recess moves to the upstream end of the laminate 70 while being pressed by the adhesive layer 40. Alternatively, the cured resin 30 that has not been able to be filled in the recess may be filled in the recess of the next laminate 70 on the upstream side.

Note that after the cured resin 30 is filled in the recess of the laminate 70, the laminate 70 may be pressed again from the surface on the thermoplastic resin layer 20 side. Further, a squeegee may be applied instead of the pressing roller 92.

### Curing Process P4

This process is a process of curing the cured resin 30 filled in the recess. For example, when the cured resin 30 is an ultraviolet curable resin, the cured resin 30 filled in the recess is irradiated with ultraviolet light to be cured.

In addition, when the cured resin 30 is a thermosetting resin, the thermosetting resin may be cured by being left at room temperature, or may be cured in a short time by being heated instead of being left at room temperature. However, when the thermosetting resin is cured by being left at room temperature, heating equipment is unnecessary, and thus the stereoscopic emblem 1 can be easily manufactured.

In this way, the recess is filled with the cured resin 30 by this process.

### Trimming Process P5

This process is mainly a process of cutting the laminate to which the adhesive layer 40 is attached into a predetermined size. Note that the resin protruding from the laminate 70 and the adhesive layer 40 may be removed before and after the laminate 70 is cut out. In addition, burr may be removed after the laminate 70 is cut out.

Through the lamination process P1, the molding process P2, the filling process P3, the curing process P4, and the trimming process P5, the stereoscopic emblem 1 as illustrated in FIG. 1 is manufactured.

According to such a method of manufacturing a stereoscopic emblem, since the thermoplastic resin layer 20 is stacked on the retroreflective sheeting 10, a laminate having higher rigidity than a case where the thermoplastic resin layer 20 is not stacked can be embossed. Therefore, a more accurate embossed shape can be transferred to the laminate.

In addition, the filling process P3 of the present embodiment includes a step of pressing the adhesive layer 40 against a first portion other than the recess on the other surface of the thermoplastic resin layer 20 using the pressing roller 92, and a step of moving the pressing roller 92 from the first portion to a second portion other than the recess through above the recess to bond the adhesive layer 40 to the thermoplastic resin layer 20. According to such a process, since the rigidity of the laminate 70 is maintained high at the stage of filling the cured resin 30, the cured resin 30 can be filled without deforming the embossed shape formed in the laminate 70 even when pressure is applied to the laminate 70 from the pressing roller 92. In addition, the cured resin 30 filled in the space as the recess is cured, so the strength of the embossed portion can be increased.

Note that in the lamination process P1, a predetermined protective film may be provided on the surface of the surface protective layer 300 on the side opposite to the retroreflective sheeting 10. The protective film may be, for example, low-density polyethylene, and the thickness of the protective film may be, for example, 35 μm or more and 40 μm or less. By providing such a protective film, the surface protective layer 300 can be protected in each process. In addition, the protective film may be peeled off after the trimming process P5.

In addition, in the present embodiment, it is not essential to provide the surface protective layer 300. However, as described above, by providing the surface protective layer 300, the retroreflective sheeting 10 can be effectively protected

### Second Embodiment

Next, a second embodiment will be described. Components that are the same as or equivalent to those of the first embodiment are denoted by the same reference numerals and redundant description is omitted unless otherwise specified.

FIG. 11 is a diagram illustrating a stereoscopic emblem 1 according to the present embodiment from the same viewpoint as FIG. 2. As illustrated in FIG. 11, the stereoscopic emblem 1 of the present embodiment does not have a surface protective layer 300, an adhesive layer 310, an adhesive layer 50, and a thermoplastic resin layer 20. In this respect, the stereoscopic emblem 1 of the present embodiment is different from the stereoscopic emblem 1 of the first embodiment. In a retroreflective sheeting 10 of the stereoscopic emblem 1 of the present embodiment, a surface F3 of a holding body layer 12 where light is incident and emitted protrudes, and a recess 1D is formed on a surface F6 of a specular reflection layer 16 facing the protruding surface F3. Then, a cured resin 30 is provided in the recess 1D.

In the present embodiment, since the thermoplastic resin layer 20 is not provided unlike the first embodiment, the configuration of the stereoscopic emblem 1 is simpler than that of the first embodiment.

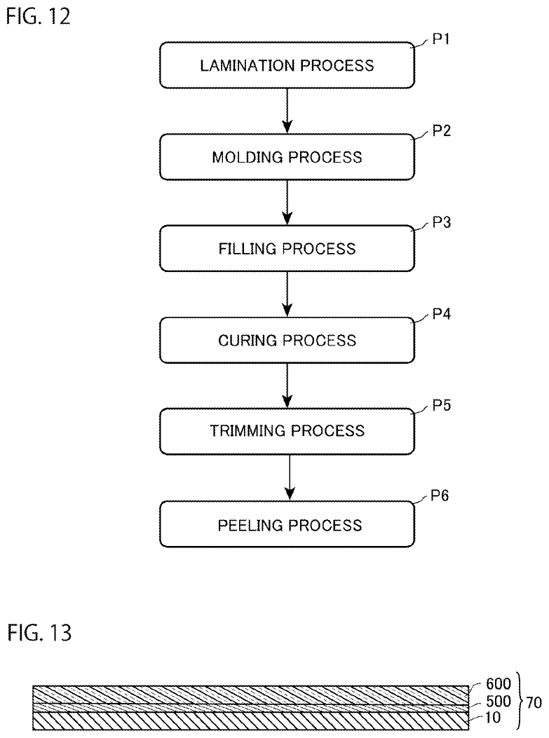

Next, an example of a method of manufacturing the stereoscopic emblem 1 of the present embodiment will be described. FIG. 12 is a flowchart illustrating an example of the manufacturing method. As illustrated in FIG. 12, the manufacturing method includes a lamination process P1, a molding process P2, a filling process P3, a curing process P4, a trimming process P5, and a peeling process P6 as main processes. In this respect, the manufacturing method of the present embodiment is different from the manufacturing method of the first embodiment that does not include the peeling process P6.

### Lamination Process P1

FIG. 13 is a diagram illustrating a state of this process. As illustrated in FIG. 13, first, the thermoplastic resin layer 600 is stacked on the surface of the retroreflective sheeting 10 on the holding body layer 12 side with the protective film 500 interposed therebetween to form a laminate 70. Note that as a material of the protective film 500, for example, low-density polyethylene can be exemplified. In addition, examples of the material of the thermoplastic resin layer 600 may include an ABS resin, a PC resin, and a PET resin. In addition, the thickness of the thermoplastic resin layer 600 may be, for example, 170 μm or more and 230 μm or less.

### Molding Process P2

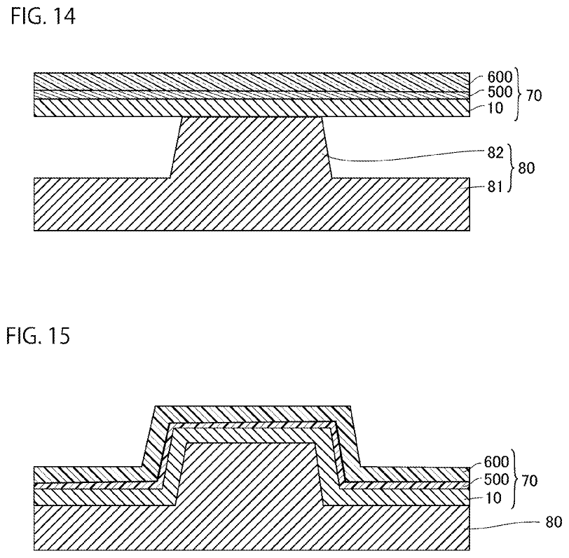

FIG. 14 is a diagram illustrating a state before embossing molding in this process. FIG. 15 is a diagram illustrating a state after the embossing molding in this process. As illustrated in FIG. 14, in this process, the laminate 70 is embossed using a convex mold 80 as in the first embodiment. In this process, first, the laminate 70 is mounted on a protrusion 82 such that the surface of the laminate 70 on the retroreflective sheeting 10 side faces the protrusion 82 of the convex mold 80.

Next, as illustrated in FIG. 15, the laminate 70 is embossed by, for example, vacuum or pressure molding so that the thermoplastic resin layer 600 side of the laminate 70 protrudes. Alternatively, the thermoplastic resin layer 600 side of the laminate 70 may protrude by pressing the convex mold and the concave mold onto the laminate 70. Note that in this process, it is preferable to heat and soften the laminate 70 and then emboss the laminate.

In this way, the predetermined embossed shape is transferred to the laminate 70. In the present embodiment, a trapezoidal recess is formed when viewed from the retroreflective sheeting 10 side of the laminate 70, and a trapezoidal protrusion is formed when viewed from the thermoplastic resin layer 600 side of the laminate 70. Note that the shape of the protrusion formed in the laminate 70 by the embossing is characters, symbols, figures, or the like.

### Filling Process P3

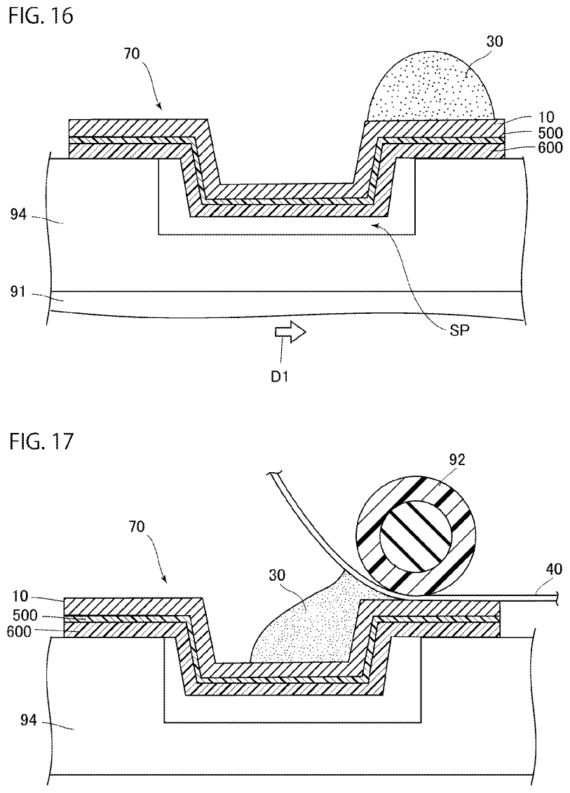

This process is performed using the filling device illustrated in FIG. 8 as in the first embodiment. FIG. 16 is a diagram illustrating a state before filling in this process, and FIG. 17 is a diagram illustrating a state during filling in this process. As illustrated in FIG. 16, first, the laminate 70 is mounted on the pedestal 94 in a state where the protrusion formed on the laminate 70 is accommodated in the accommodation space SP of the pedestal 94.

Next, the cured resin 30 is injected at a predetermined pressure by a predetermined amount through the resin injection nozzle 93 with respect to a first portion other than the recess in the surface of the laminate 70 on the retroreflective sheeting 10 side, and the cured resin 30 is disposed at the portion. In the case of the present embodiment, first, the pressing roller 92 is disposed on the downstream side in the conveyance direction D1 with respect to the recess in the peripheral edge of the recess. Next, the pedestal 94 moves in the conveyance direction D1, and the pressing roller 92 rotates in the rotation direction D2. In this way, as illustrated in FIG. 17, the adhesive layer 40 is pressed against the first portion by the pressing roller 92. In this state, the pressing roller 92 passes above the recess from the first portion and moves to the second portion other than the recess. As a result, the adhesive layer 40 is pressure-bonded to the surface of the laminate 70 on the retroreflective sheeting 10 side, and the recess of the laminate 70 is filled with the cured resin 30. In addition, the cured resin 30 that has not filled in the recess moves to the upstream end of the laminate 70 while being pressed by the adhesive layer 40. Alternatively, the cured resin 30 that has not been able to be filled in the recess may be filled in the recess of the next laminate 70 on the upstream side.

Note that after the cured resin 30 is filled in the recess of the laminate 70, the laminate 70 may be pressed again from the surface on the thermoplastic resin layer 20 side. Further, a squeegee may be applied instead of the pressing roller 92.

### Curing Process P4

Since this process is similar to the curing process P4 of the first embodiment, the description thereof will be omitted.

### Trimming Process P5

Since this process is similar to the trimming process P5 of the first embodiment, the description thereof will be omitted.

### Peeling Process P6

This process is a process of peeling off the protective film 500 and the thermoplastic resin layer 600 from the laminate 70. For example, one or a plurality of positions at one end of the protective film 500 are gripped, and a predetermined force is applied from the one end toward the other end opposite thereto, to collectively peel off the protective film 500 and the thermoplastic resin layer 600.

Through such lamination process P1, the molding process P2, the filling process P3, the curing process P4, the trimming process P5, and the peeling process P6, the stereoscopic emblem 1 as illustrated in FIG. 11 is manufactured.

According to such a method of manufacturing a stereoscopic emblem, the rigidity of the laminate can be enhanced by laminating the thermoplastic resin layer 600, and thus a more accurate embossed shape can be transferred to the laminate as compared with a case where the thermoplastic resin layer 600 is not stacked.

In addition, in the filling process P3 of the present embodiment, a pressing roller 92 is pressed against the laminate 70 in which the thermoplastic resin layers 600 are stacked to enhance the rigidity. Therefore, the cured resin 30 can be filled without deforming the embossed shape formed in the laminate 70 as compared with the case where the pressing roller 92 is pressed against the laminate in which the thermoplastic resin layer 600 is not stacked. In addition, the cured resin 30 filled in the space as the recess is cured, so the strength of the embossed portion can be increased.

In addition, in this method of manufacturing the stereoscopic emblem, since the thermoplastic resin layer 600 is peeled off after the embossing molding, it is possible to suppress the rigidity of the stereoscopic emblem from becoming excessively large to such an extent that the curved surface followability of the stereoscopic emblem is lost.

Further, according to the method of manufacturing the stereoscopic emblem of the present embodiment, the filling process P3 is performed before the thermoplastic resin layer 600 is peeled off, and the cured resin 30 is filled in the recess formed on the surface of the laminate 70 on the retroreflective sheeting 10 side. Then, after the cured resin 30 is cured, the peeling process P6 is performed. Therefore, as compared with the case where the thermoplastic resin layer 600 is peeled off before the filling process P3, it is possible to suppress the deformation of the laminate 70 due to the peeling of the thermoplastic resin layer 600.

Note that in the lamination process P1, the protective film 500 may also be provided on the surface of the retroreflective sheeting 10 on the side opposite to the protective film 500. In this way, the surface of the retroreflective sheeting 10 on the retroreflective element layer 13 side can be protected.

Although the above-describe embodiments of the present invention has been described as an example, the present invention is not limited thereto.

For example, in the above embodiments, an example has been described in which a side portion 10S of the retroreflective sheeting 10 is inclined with respect to a line SL, and the recess 1D has a trapezoidal shape, but this configuration is not essential. For example, the inclination angle θ may be 0°, or the recess 1D may not have a trapezoidal shape.

In addition, in the above embodiments, the example in which the retroreflective sheeting 10 is an encapsulated bead type has been described, but this is not essential. The retroreflective sheeting 10 may be, for example, a so-called capsule bead type, a so-called prism type, or a capsule prism type.

According to the present invention, a stereoscopic emblem that is easily recognized even at night or in a dark part is provided, and can be used in the fields of, for example, stickers, decals, or the like.

1. A stereoscopic emblem, comprising:
a retroreflective sheeting in which a surface on one side where light is incident and emitted protrudes and a recess is formed on a surface on the other side facing the protruding surface on the one side;
a cured resin provided in the recess; and
an adhesive layer provided on a side opposite to the retroreflective sheeting side with respect to the cured resin.

2. The stereoscopic emblem according to claim 1, further comprising:
a thermoplastic resin layer stacked between the retroreflective sheeting and the cured resin.

3. The stereoscopic emblem according to claim 1, further comprising:
a surface protective layer stacked on an opposite side to the adhesive layer side with respect to the retroreflective sheeting.

4. The stereoscopic emblem according to claim 2, further comprising:
a surface protective layer stacked on an opposite side to the adhesive layer side with respect to the retroreflective sheeting.
